(19) United States
(12) Patent Application Publication
(10) Pub. No.: US 2024/0097145 A1
(43) Pub. Date: Mar. 21, 2024

(54) LAYERED DOUBLE HYDROXIDE, METHOD FOR PRODUCING LAYERED DOUBLE HYDROXIDE, AIR ELECTRODE, AND METAL-AIR SECONDARY BATTERY

(71) Applicant: NGK INSULATORS, LTD., Nagoya-City (JP)

(72) Inventors: Yukari SAKURAYAMA, Nagoya-City (JP); Ozora KANO, Nagoya-City (JP)

(73) Assignee: NGK INSULATORS, LTD., Nagoya-City (JP)

(21) Appl. No.: 18/520,655

(22) Filed: Nov. 28, 2023

Related U.S. Application Data
(63) Continuation of application No. PCT/JP2022/009438, filed on Mar. 4, 2022.

(30) Foreign Application Priority Data
Jul. 2, 2021 (JP) 2021-110502

(51) Int. Cl. H01M 4/90; B01J 23/889; B01J 37/02; H01M 4/88; H01M 12/08

(52) U.S. Cl. CPC H01M 4/9016; B01J 23/8892; B01J 37/0213; H01M 4/88; H01M 12/08

(57) ABSTRACT

A layered double hydroxide contains four elements of Ni, Fe, V, and Co, and further contains Mn as a fifth element.

### CROSS-REFERENCE TO RELATED APPLICATIONS

This application is a continuation under 35 U.S.C. 120 of International Application PCT/JP2022/009438 having the International Filing Date of Mar. 4, 2022, and having the benefit of the earlier filing date of Japanese Application No. 2021-110502, filed on Jul. 2, 2021. Each of the identified applications is fully incorporated herein by reference.

### BACKGROUND OF THE INVENTION

### Technical Field

The present invention relates to a layered double hydroxide, a method of producing a layered double hydroxide, an air electrode, and a metal-air secondary battery.

### Background Art

As a candidate for an innovative battery, there is given a metal-air secondary battery. The metal-air secondary battery is a secondary battery using a metal in a negative electrode and using oxygen and/or water in air as an active material in a positive electrode. In the positive electrode (air electrode) of the metal-air secondary battery, the following electrochemical reactions occur: hydroxide ions are produced at the time of discharge (oxygen reduction reaction, hereinafter “ORR”) and oxygen is evolved at the time of charge (oxygen evolution reaction, hereinafter “OER”). In order to promote the ORR/OER reactions, for example, a catalyst having high activity is needed.

As a catalyst for the air electrode, a layered double hydroxide (LDH), which is utilized in various applications as disclosed in Patent Literature 1, and has a plurality of hydroxide layers and an intermediate layer interposed between the hydroxide layers, is drawing attention. In recent years, progress has been made in practical application of a binary LDH, such as a Ni—Fe—based LDH or a Ni—Co-based LDH, as a catalyst for an air electrode, but the LDH still has room for many improvements as a catalyst.

### CITATION LIST

### Patent Literature

[PTL 1] WO 2017/221497 A1

### SUMMARY OF THE INVENTION

The present invention has been made in order to solve the problem of the related art described above, and a primary object of the present invention is to provide a layered double hydroxide having an excellent catalytic function (e.g., oxygen-evolving catalytic function).

According to an embodiment of the present invention, there is provided a layered double hydroxide, containing four elements of Ni, Fe, V, and Co, and further containing Mn as a fifth element.

In one embodiment, the layered double hydroxide has an atomic ratio (Ni+Mn)/(Ni+Fe+V+Co+Mn) of 0.6 or more and 0.8 or less, which is determined by energy-dispersive X-ray spectroscopy (EDS).

In one embodiment, the layered double hydroxide has an atomic ratio Mn/Ni of 0.2 or more and 0.8 or less, which is determined by energy-dispersive X-ray spectroscopy (EDS).

In one embodiment, the layered double hydroxide has an atomic ratio Mn/(Ni+Fe+V+Co+Mn) of more than 0 and 0.4 or less, which is determined by energy-dispersive X-ray spectroscopy (EDS).

According to another aspect of the present invention, there is provided a method of producing the layered double hydroxide. The production method includes: preparing a solution of salts of Ni, Fe, V, Co, and Mn dissolved in an aqueous medium at respective predetermined molar ratios; adding acetylacetone during the preparing a solution or after the preparing; adding propylene oxide to the solution having added thereto acetylacetone; and leaving the solution having added thereto propylene oxide to stand for a predetermined period of time.

In one embodiment, the production method includes: leaving the solution having added thereto propylene oxide to stand for a predetermined period of time to provide a gel; and leaving the gel to stand for a predetermined period of time to provide a sol.

According to still another aspect of the present invention, there is provided an air electrode. The air electrode includes: a porous current collector; and a catalyst layer containing the above-mentioned layered double hydroxide, the catalyst layer covering at least part of the porous current collector.

According to yet still another aspect of the present invention, there is provided a metal-air secondary battery. The metal-air secondary battery includes: the above-mentioned air electrode; a separator; an electrolytic solution; and a metal negative electrode.

In one embodiment, the separator is a hydroxide ion conductive dense separator, and the electrolytic solution is separated from the air electrode by the separator.

### Advantageous Effects of Invention

According to the embodiments of the present invention, the layered double hydroxide contains the four elements of Ni, Fe, V, and Co, and thus can achieve an excellent catalytic function.

### BRIEF DESCRIPTION OF THE DRAWINGS

FIG. 1 is a schematic view for illustrating a schematic configuration of a metal-air secondary battery according to one embodiment of the present invention.

FIG. 2 is an enlarged view of an example of part of an air electrode of the metal-air secondary battery illustrated in FIG. 1.

FIG. 3 is a cross-sectional view for conceptually illustrating an example of a separator (hydroxide ion conductive dense separator) of the metal-air secondary battery illustrated in FIG. 1.

FIG. 4A shows an X-ray diffraction pattern of Example 1.

FIG. 4B shows an SEM image and elemental mapping images of Example 1.

FIG. 5 is a graph for comparatively showing relationships between a potential with respect to a hydrogen electrode and a current density for Example 1, Comparative Example 1, and Comparative Example 3.

### DESCRIPTION OF EMBODIMENTS

Embodiments of the present invention are described below. However, the present invention is not limited to these embodiments.

A. Layered Double Hydroxide

A layered double hydroxide (LDH) according to an embodiment of the present invention contains four elements of Ni, Fe, V, and Co. Specifically, the LDH may be an LDH in which at least those four elements are composited. By virtue of the incorporation of at least the four elements of Ni, Fe, V, and Co, an excellent catalytic function (e.g., oxygen-evolving catalytic function) can be achieved. Specifically, in catalytic activity evaluation in the case of using the LDH as a catalyst for an air electrode of a metal-air secondary battery, its onset potential can be lowered, and/or a low potential (low resistance) can be achieved at a predetermined current density. This may be presumably because, for example, the large number of elements contained in the LDH increases the number and/or density of active sites, and also increases the interaction between such active sites. Presumptions made herein about effects and mechanisms do not limit the present invention, and the present invention is not bound by such presumptions.

The LDH may contain, in addition to the above-mentioned four elements, at least one kind of fifth element selected from the group consisting of: Mn; Al; Zn; W; Cr; and Ru. Specifically, the LDH may be an LDH in which at least the fifth element is composited. Through the incorporation of the fifth element, a more excellent catalytic function (e.g., oxygen-evolving catalytic function) can be achieved.

The ratio of Ni to the total of Ni, Fe, V, Co, and as required, the fifth element (which are hereinafter sometimes collectively referred to as “constituent elements”) in the LDH, specifically, an atomic ratio Ni/(Ni+Fe+V+Co) or an atomic ratio Ni/(Ni+Fe+V+Co+ fifth element) is preferably 0.3 or more and 0.8 or less, more preferably 0.35 or more and 0.75 or less, still more preferably 0.4 or more and 0.7 or less. An atomic ratio Fe/(Ni+Fe+V+Co) or an atomic ratio Fe/(Ni+Fe+V+Co+ fifth element) is preferably more than 0 and 0.3 or less, more preferably 0.005 or more and 0.25 or less, still more preferably 0.01 or more and 0.2 or less. An atomic ratio V/(Ni+Fe+V+Co) or an atomic ratio V/(Ni+Fe+V+Co+ fifth element) is preferably 0.04 or more and 0.49 or less, more preferably 0.06 or more and 0.35 or less, still more preferably 0.07 or more and 0.3 or less. An atomic ratio Co/(Ni+Fe+V+Co) or an atomic ratio Co/(Ni+Fe+V+Co+ fifth element) is preferably more than 0 and 0.2 or less, more preferably 0.005 or more and 0.18 or less, still more preferably 0.01 or more and 0.17 or less. With such ranges, a more excellent catalytic function (e.g., oxygen-evolving catalytic function) can be achieved.

In a preferred embodiment, the LDH contains at least Mn as the fifth element. The use of Mn, which is inexpensive, can contribute to a reduction in cost. In this embodiment, an atomic ratio Mn/(Ni+Fe+V+Co+Mn) is preferably more than 0 and 0.4 or less, more preferably 0.05 or more and 0.35 or less, still more preferably 0.1 or more and 0.3 or less.

The valency of each of the constituent elements of the LDH is not always certain, and hence it is substantially difficult to strictly specify the LDH by a general formula, but in general, an LDH may be represented by the following general formula (I).

(M²⁺)₁₋ₓ(M³⁺)×(OH)₂(Aⁿ⁻)_{x/n}mH₂O (I)

In the formula (I), M²⁺ represents at least one kind of divalent cation, M³⁺ represents at least one kind of trivalent cation, Aⁿ⁻ represents an n-valent anion, “n” represents an integer of 1 or more, and “m” represents any appropriate real number (of more than 0).

If it is assumed that the hydroxide layers of the LDH mainly include Ni, Fe, V, Co, and Mn, for example, in the general formula (I), M²⁺ may include Ni²⁺ and Mn²⁺, and M³⁺ may include Fe³⁺, V³⁺, and Co³⁺. An atomic ratio (Ni+Mn)/(Ni+Fe+V+Co+Mn) is preferably 0.6 or more. Meanwhile, the atomic ratio (Ni+Mn)/(Ni+Fe+V+Co+Mn) is preferably 0.8 or less, more preferably 0.75 or less, still more preferably 0.7 or less. An atomic ratio Mn/Ni is preferably 0.2 or more and 0.8 or less, more preferably 0.25 or more and 0.75 or less, still more preferably 0.3 or more and 0.7 or less.

In another embodiment, the LDH contains at least Al as the fifth element. In this embodiment, an atomic ratio Al/(Ni+Fe+V+Co+Al) is preferably more than 0 and 0.2 or less, more preferably 0.005 or more and 0.15 or less, still more preferably 0.01 or more and 0.1 or less.

In still another embodiment, the LDH contains at least Zn as the fifth element. In this embodiment, an atomic ratio Zn/(Ni+Fe+V+Co+Zn) is preferably more than 0 and 0.3 or less, more preferably 0.005 or more and 0.25 or less, still more preferably 0.01 or more and 0.2 or less.

The above-mentioned ratios (atomic ratios) may be determined through composition analysis by energy-dispersive X-ray spectroscopy (EDS). For example, the composition analysis may be performed using an energy-dispersive X-ray analyzer (e.g., X-act manufactured by Oxford Instruments plc), followed by the calculation of the ratios (atomic ratios) from the results of the analysis.

The LDH may have a plurality of hydroxide layers and an intermediate layer interposed between the hydroxide layers. Typically, the hydroxide layers each contain the constituent elements (typically in ionic states) and OH groups, and the intermediate layer contains an anion and H₂O. The anion is any appropriate anion that is monovalent or higher. Specific examples of the anion include NO₃⁻, CO₃²⁻, SO₄²⁻, OH⁻, and halide ions such as Cl⁻. Of those, CO₃²⁻, OH⁻, and Cl⁻ are preferred. The intermediate layer may contain one kind of anion, or may contain two or more kinds of anions.

Typically, the LDH is provided in the form of particles. In one embodiment, the LDH is provided as plate-like particles, and may have any appropriate plan view shape. Specific examples of the plan view shape include a circular shape, an oval shape, a rectangular shape, a triangular shape, a polygonal shape, and an indefinite shape. The size of the LDH (long diameter of a primary particle) is, for example, from 1 nm to 0.2 μm, and the thickness thereof is, for example, from 0.5 nm to 50 nm. Herein, the “size of the LDH” refers to the size of the plan view shape of the LDH, and for example, refers to the diameter in the case of a circular shape, the long diameter in the case of an oval shape, and the length of a long side in the case of a rectangular shape. The size and thickness of the LDH may be measured by, for example, scanning electron microscope (SEM) observation.

B. Production of Layered Double Hydroxide

The LDH may be produced by any appropriate method. In one embodiment, the LDH may be produced by a so-called sol-gel method. For example, the method of producing the LDH includes: preparing a solution of salts of Ni, Fe, V, Co, and as required, the fifth element (in one embodiment, Mn) dissolved in an aqueous medium at respective predetermined molar ratios; adding acetylacetone during the preparing a solution or after the preparing (to the aqueous medium or the solution); adding propylene oxide to the solution having added thereto acetylacetone; and leaving the solution having added thereto propylene oxide to stand for a predetermined period of time.

Any appropriate salts capable of forming the intermediate layer are typically used as the salts to be used for the preparation of the solution. Examples of the salts include nitrates, carbonates, sulfates, hydroxides, and halides (chlorides, iodides, bromides, and fluorides). For example, chlorides are used as the salts. The chlorides are inexpensive and easily available, and each have high solubility in the aqueous medium to be described later. The salts of the constituent elements may be salts of the same kind (e.g., chlorides), or may be salts of different kinds. With regard to the valence (valency) of each of the constituent elements, the valence in its raw material (salt) and the valence in the LDH to be obtained may be the same or different. A specific example of a case in which the valences are different may be as follows: CoCl₂ is adopted as the starting raw material (salt) of Co, and Co assumes the form of Co³⁺ in the LDH to be obtained.

The usage amounts (loading ratios) of the salts of the constituent elements are adjusted in accordance with, for example, the intended composition of the LDH.

The above-mentioned aqueous medium typically contains water. For example, tap water, ion-exchanged water, pure water, or ultrapure water is used as the water. Of those, ultrapure water is preferred. Ultrapure water contains extremely small amounts of impurities, and hence, for example, has an extremely small influence on reactions and allows an LDH with extremely small amounts of impurities to be obtained. The aqueous medium may contain a hydrophilic organic solvent. Examples of the hydrophilic organic solvent include alcohols, such as ethanol and methanol. The hydrophilic organic solvent may be preferably used in the range of from 100 parts by weight to 200 parts by weight with respect to 100 parts by weight of the water.

At the time of the preparation of the solution, stirring is preferably performed. When the stirring is performed, an LDH of composition that is uniform and extremely close to design values can be obtained. A stirring time is, for example, from 5 minutes to 30 minutes.

Acetylacetone is added to the aqueous medium or the solution. Specifically, acetylacetone may be added during the preparation of the solution, or may be added after the preparation of the solution. The addition of acetylacetone can achieve spontaneous gelation to be described later and subsequent spontaneous deflocculation, and as a result, can provide the LDH as fine particles (suppress flocculation and/or sedimentation). That is, the growth and stabilization of the LDH particles, which are in a trade-off relationship, can both be achieved.

The addition amount of acetylacetone is preferably from 0.008% to 0.036% (molar ratio), more preferably from 0.016% to 0.018% (molar ratio) with respect to the total amount of the constituent elements. When the addition amount of acetylacetone falls within such ranges, for example, an LDH with extremely small amounts of impurities can be obtained.

As required, the solution having added thereto acetylacetone is stirred. A stirring time is, for example, from 15 minutes to 60 minutes.

Propylene oxide is added to the solution having added thereto acetylacetone. Propylene oxide may function as a proton scavenger through the protonation of epoxy oxygen and subsequent ring opening by a nucleophilic substitution reaction with a conjugate base. Through such protonation and ring opening, the pH of the solution can be increased to promote the crystallization of the LDH (e.g., formation of particles) through coprecipitation. The addition amount of propylene oxide is preferably from 0.12% to 0.48% (molar ratio), more preferably from 0.23% to 0.25% (molar ratio) with respect to the total amount of the constituent elements.

The solution having added thereto propylene oxide is left to stand for a predetermined period of time (e.g., from 12 hours to 36 hours). Specifically, the above-mentioned production method may include: leaving the solution having added thereto propylene oxide to stand for a predetermined period of time to provide a gel; and leaving the obtained gel to stand for a predetermined period of time to provide a sol.

After the addition of propylene oxide, the solution may gel. Specifically, a gel containing a composite of the constituent elements may be formed. It is presumed that, substantially, the LDH as a composite has been formed by this time, and the LDH flocculates to form the gel. The period of time for which the solution is left to stand until the formation of a gel is, for example, from 1 hour to 6 hours, preferably from 2 hours to 4 hours. As required, before being left to stand (i.e., immediately after the addition of propylene oxide), the solution may be stirred for a short period of time (e.g., from 30 seconds to 2 minutes).

The gel formed in the foregoing is left to stand for a predetermined period of time. The gel may be deflocculated to form a sol containing LDH particles (e.g., plate-like fine particles). The period of time for which the gel is left to stand until the formation of a sol is, for example, 5 hours or more, preferably from 6 hours to 30 hours.

The sol may be subjected to drying treatment. For example, the drying may be performed at room temperature (about 23° C.) from the viewpoint of suppressing the flocculation of the particles to be obtained, or may be performed using a dryer. In the latter case, the drying temperature is preferably from 60° C. to 90° C., more preferably from 70° C. to 80° C. In addition, the drying may be performed under reduced pressure (e.g., vacuum drying). Each of the above-mentioned steps may be performed at room temperature (about 23° C.)

The sol-gel method may be specifically performed in conformity with, for example, a method described in ACS Nano 2016, 10, 5550-5559. The description of the document is incorporated herein by reference.

In one embodiment, production of the LDH by the sol-gel method is performed in the presence of a substrate (e.g., a porous sheet). For example, the production of the LDH is performed under a state in which the substrate is immersed in the above-mentioned aqueous medium. With such form, the LDH can be directly formed on the surface of the substrate. The above-mentioned porous sheet may correspond to a porous current collector of an air electrode to be described later. Accordingly, this embodiment may also be a method of producing an air electrode. In this embodiment, the production of the LDH and the binding and/or adhesion of the LDH to the porous current collector may be simultaneously performed.

In another embodiment, the LDH may be produced by a coprecipitation method. For example, the method of producing the LDH includes adding dropwise an aqueous solution of raw materials containing the constituent elements into an aqueous solution containing carbonate ions under the condition of a pH of from 9.5 to 12 to cause a reaction. For the adjustment of the pH, for example, an aqueous solution of NaOH is used. The resulting reaction product is grown by, for example, being stirred for a predetermined period of time as required. The resulting reaction product may be dried and/or crushed to provide LDH particles.

The production of the LDH may be recognized by, for example, X-ray diffractometry. Typically, there may be detected a first peak at a diffraction angle 20 in the range of from 10° to 12°, a second peak at a diffraction angle 20 in the range of from 22° to 24°, and a third peak at a diffraction angle 20 in the range of from 33° to 35°. The first peak may correspond to a (003) peak of the LDH, the second peak may correspond to a (006) peak of the LDH, and the third peak may correspond to a (012) peak of the LDH.

The LDH contains the four elements of Ni, Fe, V, and Co, and further, the fifth element, and thus can achieve an excellent catalytic function (e.g., oxygen-evolving catalytic function) irrespective of its production method (be it the sol-gel method or the coprecipitation method, for example).

C. Metal-Air Secondary Battery

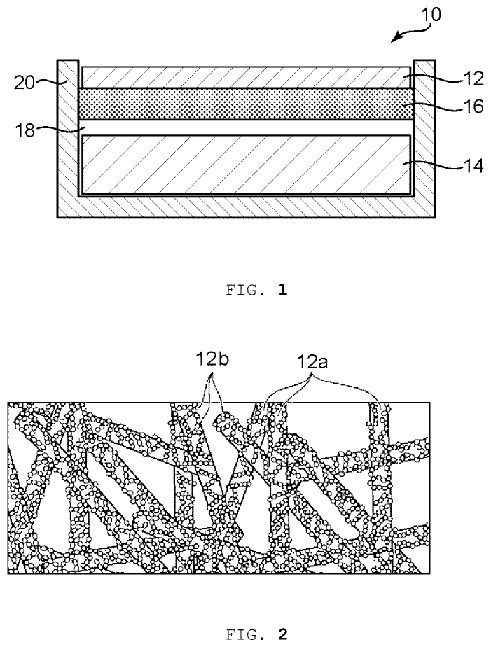

FIG. 1 is a schematic view for illustrating a schematic configuration of a metal-air secondary battery according to one embodiment of the present invention. A metal-air secondary battery 10 includes an air electrode (positive electrode) 12, a metal negative electrode 14, a separator 16 arranged between the air electrode 12 and the metal negative electrode 14, and an electrolytic solution 18, which are accommodated in a container 20. The air electrode 12 is accommodated in the container 20 in a state of being able to be brought into contact with external air.

In the illustrated example, the separator 16 is arranged adjacent to the air electrode 12, and the electrolytic solution 18 is separated from the air electrode 12 by the separator 16. The metal negative electrode 14 is immersed in the electrolytic solution 18. The metal negative electrode 14 may be formed of any appropriate metal. Typically, the metal negative electrode 14 contains zinc or a zinc alloy. Specifically, the metal-air secondary battery 10 is provided as a zinc-air secondary battery. A strongly alkaline aqueous solution having a pH of about 14 (e.g., an aqueous solution of potassium hydroxide) is typically used as the electrolytic solution 18.

C-1. Air Electrode

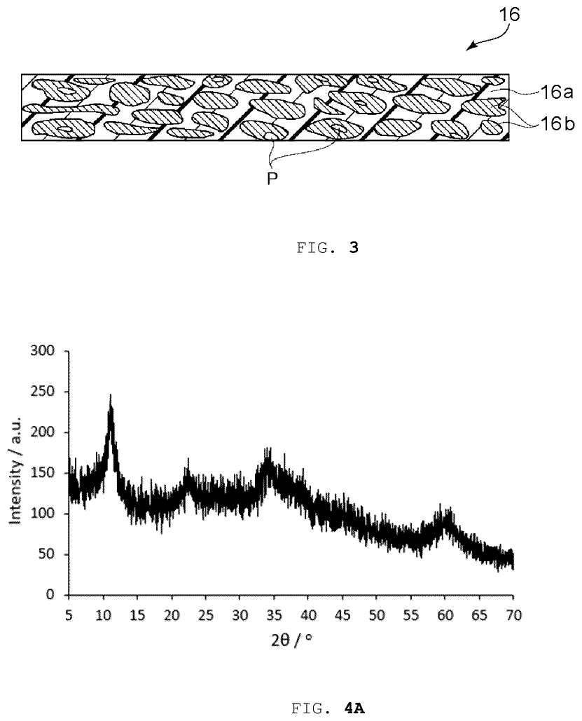

FIG. 2 is an enlarged view of an example of part of the air electrode of the metal-air secondary battery illustrated in FIG. 1. The air electrode 12 includes a porous current collector 12a and a catalyst layer 12b covering the surface of the porous current collector 12a. The catalyst layer 12b contains the LDH.

Any appropriate configuration applicable to an air electrode of a metal-air secondary battery may be adopted for the above-mentioned porous current collector. The porous current collector may be typically formed of an electroconductive material having gas diffusibility. Specific examples of such electroconductive material include carbon, nickel, stainless steel, titanium, and combinations thereof. Of those, carbon is preferred. As a specific configuration of the porous current collector, there are given carbon paper, nickel foam, a nonwoven fabric made of stainless steel, and combinations thereof. Of those, carbon paper is preferred. Carbon fibers for forming the carbon paper each have a fiber diameter of, for example, from 10 μm to 20 μm. A commercially available porous material may be used as the porous current collector. The thickness of the porous current collector is preferably from 0.1 mm to 1 mm, more preferably from 0.1 mm to 0.5 mm, still more preferably from 0.1 mm to 0.3 mm. When the thickness falls within such ranges, for example, a wide reaction region, specifically, a wide three-phase interface formed of an ion conductive phase (the LDH), an electron conductive phase (the porous current collector), and a gas phase (air) can be secured. The porosity of the porous current collector (substantially the air electrode) is preferably from 60% to 95%. When the porous current collector is carbon paper, the porosity is more preferably from 60% to 90%. When the porosity falls within such ranges, for example, excellent gas diffusibility can be secured, and besides, a wide reaction region can be secured. In addition, pore (void) portions are increased, and hence are less liable to be clogged up with produced water. The porosity may be measured by a mercury intrusion method.

The air electrode is produced by, for example, precipitating the LDH on the porous current collector. Specifically, the production of the LDH may be performed in the presence of the porous current collector. In one embodiment, in the air electrode 12, the LDH in the form of particles (e.g., plate-like fine particles) binds and/or adheres (e.g., binds) to the surface of the porous current collector 12a to form the catalyst layer 12b.

The catalyst layer 12b may contain a second LDH different in composition from the above-mentioned LDH. Specifically, the LDH for forming the catalyst layer 12b may be of a single composition, or may be a mixture of two or more kinds of LDHs having different compositions. The LDH typically has the form of plate-like particles, and the LDH may bind, for example, over the entirety of the porous current collector (as a result, may cover the entirety of the porous current collector), or may bind, for example, to part of the porous current collector (as a result, may cover part of the porous current collector). In one embodiment, the LDHs (plate-like particles) bind, for example, so that the principal surface thereof may be in a perpendicular or oblique direction with respect to the surface of the porous current collector. In addition, in one embodiment, the LDHs (plate-like particles) are linked to each other. With such configuration, reaction resistance can be reduced. The LDH may function not only as a catalyst (air electrode catalyst) but also as a hydroxide ion conductive material in the air electrode.

When the catalyst layer 12b is formed of a mixture of two or more kinds of LDHs having different compositions, the sizes of the LDHs (plate-like particles) of the respective compositions are typically different from each other. With such configuration, the strength for being supported on the porous current collector 12a can be secured. Further, in one embodiment, LDHs (plate-like particles) having a larger size bind, for example, so that the principal surface thereof may be in a perpendicular or oblique direction with respect to the surface of the porous current collector 12a. With such configuration, the diffusion of oxygen into the porous current collector 12a can be promoted, and besides, the amount of the LDHs supported on the porous current collector 12a can be increased.

The above-mentioned air electrode may further contain an air electrode catalyst and/or a hydroxide ion conductive material other than the LDH. Specific examples of the air electrode catalyst and/or the hydroxide ion conductive material other than the LDH include a metal oxide, metal nanoparticles, a carbon material, and combinations thereof. In addition, the above-mentioned air electrode may further contain a material capable of adjusting a water content. In one embodiment, the LDH may function as such material. Other specific examples of the material capable of adjusting a water content include a zeolite, calcium hydroxide, and a combination thereof.

The air electrode 12 may be formed of such a single layer including the porous current collector 12a and the catalyst layer 12b covering the surface of the porous current collector 12a as illustrated in FIG. 2, or may have, in addition to such an outer layer including the porous current collector 12a and the catalyst layer 12b covering the surface of the porous current collector 12a as illustrated in FIG. 2, an inner layer, which has a configuration different from that of the outer layer, formed on the side on which the separator 16 is arranged (inner side).

The inner layer is formed by, for example, filling a predetermined portion of the porous current collector on the inner side (end portion in a thickness direction) with a mixture containing a hydroxide ion conductive material, an electroconductive material, an air electrode catalyst, and an organic polymer.

Any appropriate material having hydroxide ion conductivity may be used as the hydroxide ion conductive material. The hydroxide ion conductive material is preferably an LDH. The LDH is not limited to the LDH according to the embodiment of the present invention described in the foregoing section A, and any appropriate LDH may be used. The LDH may be typically represented by the following general formula (II).

(M²⁺)_{1-Y}(M³⁺)_{Y}(OH)₂(Aⁿ⁻)_{Y/n}·MH₂O (II)

In the formula (II), M²⁺ represents at least one kind of divalent cation, M³⁺ represents at least one kind of trivalent cation, Aⁿ⁻ represents an n-valent anion, “n” represents an integer of 1 or more, “m” represents any appropriate real number (of more than 0), and Y represents from 0.1 to 0.4. Examples of M²⁺ include Ni²⁺, mg²⁺, Ca²⁺, Mn²⁺, Fe²⁺, Co²⁺, Cu²⁺, and Zn²⁺. Examples of M³⁺ include Fe³⁺, Al³⁺, Co³⁺, Cr³⁺, In³⁺, and V³⁺. Specific examples of the LDH include a Mg—Al-based LDH and an LDH containing a transition metal (e.g., a Ni—Fe-based LDH, a Co—Fe-based LDH, or a Ni—Fe—V-based LDH). The hydroxide ion conductive material may be the same material as the air electrode catalyst.

Examples of the electroconductive material include electroconductive ceramics, a carbon material, and combinations thereof. Specific examples of the electroconductive ceramics include LaNiO₃ and LaSr₃Fe₃O₁₀. Specific examples of the carbon material include carbon black, graphite, carbon nanotubes, graphene, reduced graphene oxide, and combinations thereof. The electroconductive material may also be the same material as the air electrode catalyst.

Examples of the air electrode catalyst include an LDH and other metal hydroxides, a metal oxide, metal nanoparticles, a carbon material, a nitride, and combinations thereof. Of those, an LDH, a metal oxide, metal nanoparticles, a carbon material, and combinations thereof are preferred. The LDH is as described above for the hydroxide ion conductive material. Specific examples of the metal hydroxides include Ni—Fe—OH, Ni—Co—OH, and a combination thereof. Those metal hydroxides may each further contain a third metal element. Specific examples of the metal oxide include Co₃O₄, LaNiO₃, LaSr₃Fe₃O₁₀, and combinations thereof. The metal nanoparticles are typically metal particles each having a particle diameter of from 2 nm to 30 nm. Specific examples of the metal nanoparticles include Pt and a Ni—Fe alloy. As described above, specific examples of the carbon material include carbon black, graphite, carbon nanotubes, graphene, reduced graphene oxide, and combinations thereof. The carbon material may further contain a metal element and/or another element, such as nitrogen, boron, phosphorus, or sulfur. With such configuration, the catalytic performance of the carbon material can be improved. An example of the nitride is TiN.

Any appropriate binder resin may be used as the organic polymer. Specific examples of the organic polymer include a butyral-based resin, a vinyl alcohol-based resin, celluloses, and a vinyl acetal-based resin. Of those, a butyral-based resin is preferred.

The air electrode 12 may be provided as a laminate with the separator 16 in advance.

C-2. Separator

For example, a hydroxide ion conductive dense separator is used as the separator. The hydroxide ion conductive dense separator can separate the electrolytic solution from the air electrode to suppress the evaporation of water contained in the electrolytic solution. An LDH separator may be typically used as the hydroxide ion conductive dense separator. The LDH separator is typically used for a metal-air secondary battery, and such metal-air secondary battery has an excellent advantage in that both of a short circuit between positive and negative electrodes due to metal dendrites and the inclusion of carbon dioxide can be prevented. In addition, there is also an advantage in that the denseness of the LDH separator can satisfactorily suppress the evaporation of water contained in an electrolytic solution. Meanwhile, the LDH separator blocks the permeation of the electrolytic solution into the air electrode, and hence no electrolytic solution is present in the air electrode. As a result, hydroxide ion conductivity tends to be reduced, and charge-discharge performance tends to be reduced, as compared to a metal-air secondary battery using a general separator (e.g., a porous polymer separator) that permits the permeation of the electrolytic solution into the air electrode. When the laminate of the air electrode according to the embodiment of the present invention and the LDH separator is used, such inconvenience can be eliminated while the above-mentioned excellent advantages of the LDH separator are maintained. Matters mentioned regarding the LDH separator in the following description similarly apply to a hydroxide ion conductive dense separator other than the LDH separator as long as technical consistency is not impaired. That is, in the following description, “LDH separator” may be read as “hydroxide ion conductive dense separator” as long as technical consistency is not impaired.

Any appropriate configuration may be adopted for the LDH separator. For example, a configuration described in WO 2013/073292 A1, WO 2016/076047 A1, WO 2016/067884 A1, WO 2015/146671 A1, or WO 2018/163353 A1 may be adopted for the LDH separator. The descriptions of those publications are incorporated herein by reference.

In one embodiment, the LDH separator may include a

porous substrate, and a layered double hydroxide (LDH) and/or an LDH-like compound. Herein, the “LDH separator” is defined as a separator containing an LDH and/or an LDH-like compound (the LDH and the LDH-like compound may be collectively referred to as “hydroxide ion conductive layered compound”), the separator selectively allowing hydroxide ions to pass therethrough by solely utilizing the hydroxide ion conductivity of the hydroxide ion conductive layered compound. In addition, herein, the “LDH-like compound” may not be exactly called an LDH, but is a hydroxide and/or oxide of a layered crystal structure similar to the LDH, and hence may be said to be an equivalent to the LDH. However, as a broad definition, the term “LDH” may be construed as encompassing not only the LDH but also the LDH-like compound.

The LDH-like compound preferably contains Mg and Ti, and as required, Y and/or Al. When, as just described, the LDH-like compound that is a hydroxide and/or oxide of a layered crystal structure containing at least Mg and Ti is used as a hydroxide ion conductive substance in place of the related-art LDH, there can be provided a hydroxide ion conductive separator excellent in alkali resistance and capable of even more effectively suppressing a short circuit resulting from zinc dendrites. Accordingly, a preferred LDH-like compound is a hydroxide and/or oxide of a layered crystal structure containing Mg and Ti, and as required, Y and/or Al, and a more preferred LDH-like compound is a hydroxide and/or oxide of a layered crystal structure containing Mg, Ti, Y, and Al. The above-mentioned elements may be substituted with other elements or ions to such an extent that the basic characteristics of the LDH-like compound are not impaired. In one embodiment, the LDH-like compound is preferably free of Ni.

The LDH-like compound may be identified by an X-ray diffraction method. Specifically, when measurement by the X-ray diffraction method is performed on the surface of the LDH separator, a peak derived from the LDH-like compound is detected in typically the range of 5° 2010°, more typically the range of 7° 2010°. As described above, the LDH is a substance having an alternately stacked structure in which exchangeable anions and H₂O are present as an intermediate layer between stacked hydroxide layers. In this regard, when the LDH is subjected to measurement by the X-ray diffraction method, a peak attributed to the crystal structure of the LDH (i.e., a (003) peak of the LDH) is originally detected at the position of 20=11° to 12°. In contrast, when the LDH-like compound is subjected to measurement by the X-ray diffraction method, the peak is typically detected in the above-mentioned ranges shifted to a lower angle side with respect to the above-mentioned peak position of the LDH. In addition, the interlayer distance of the layered crystal structure may be determined by Bragg's equation through use of 20 corresponding to the peak derived from the LDH-like compound in an X-ray diffraction pattern. The thus determined interlayer distance of the layered crystal structure for forming the LDH-like compound is typically from 0.883 nm to 1.8 nm, more typically from 0.883 nm to 1.3 nm.

An atomic ratio Mg/(Mg+Ti+Y+Al) in the LDH-like compound determined by energy-dispersive X-ray spectroscopy (EDS) is preferably from 0.03 to 0.25, more preferably from 0.05 to 0.2. In addition, an atomic ratio Ti/(Mg+Ti+Y+Al) in the LDH-like compound is preferably from 0.40 to 0.97, more preferably from 0.47 to 0.94. Further, an atomic ratio Y/(Mg+Ti+Y+Al) in the LDH-like compound is preferably from 0 to 0.45, more preferably from 0 to 0.37. Besides, an atomic ratio Al/(Mg+Ti+Y+Al) in the LDH-like compound is preferably from 0 to 0.05, more preferably from 0 to 0.03. When the atomic ratios fall within the above-mentioned ranges, the alkali resistance becomes even more excellent, and besides, the suppressing effect on a short circuit resulting from zinc dendrites (i.e., dendrite resistance) can be more effectively achieved. Incidentally, an LDH hitherto known regarding the LDH separator may be represented by the formula (II) described above. In contrast, the atomic ratios in the LDH-like compound generally deviate from the general formula of the LDH. Accordingly, it may be said that the LDH-like compound generally has composition ratios (atomic ratios) different from those of the related-art LDH. Composition analysis by the EDS is preferably performed with an energy-dispersive X-ray analyzer (e.g., X-act manufactured by Oxford Instruments plc), for example, by: 1) capturing an image at an acceleration voltage of 20 kV and a magnification of 5,000 times; 2) performing three-point analysis at intervals of about 5 μm in the point analysis mode; 3) repeating the foregoing 1) and 2) one more time; and 4) calculating an average value for a total of six points.

It is preferred that, as conceptually illustrated in FIG. 3, the separator (LDH separator) 16 include a porous substrate (polymer porous substrate) 16a made of a polymer material, and an LDH 16b that clogs up pores of the porous substrate. Substantially, the pores of the porous substrate 16a do not need to be completely clogged up, and a small number of residual pores P may be present. By including the polymer porous substrate, the LDH separator can flex and is hardly broken even when pressurized, and hence can be accommodated in a battery container and pressurized together with other battery elements (such as a negative electrode) in a direction in which the battery elements are brought into close contact with each other. Such pressurization becomes particularly advantageous when a plurality of air electrode/separator laminates are incorporated in a battery container alternately with a plurality of metal negative electrodes to form a laminated battery. Similarly, the pressurization is also advantageous when a plurality of laminated batteries are accommodated in one module container to form a battery module. For example, when a metal-air secondary battery is pressurized, a gap allowing the growth of metal dendrites between the negative electrode and the LDH separator is minimized (preferably the gap is eliminated), and thus more effective prevention of metal dendrite growth can be expected. Further, when the polymer porous substrate is highly densified by clogging up the pores thereof with the LDH, there can be provided an LDH separator that can even more effectively suppress a short circuit resulting from metal dendrites. In FIG. 3, the regions of the LDH 16b are illustrated as if discontinuous between the upper surface and lower surface of the LDH separator 16, but this is because the regions are two-dimensionally illustrated as a cross-section. In the actual LDH separator, the regions of the LDH 16b are continuous between the upper surface and the lower surface, and thus the hydroxide ion conductivity of the LDH separator 16 is secured.

The above-mentioned polymer porous substrate has such advantages as described below: 1) the substrate has flexibility (accordingly, is hardly broken even when reduced in thickness); 2) the substrate easily achieves a high porosity; 3) the substrate easily achieves a high conductivity (because it is possible to reduce the thickness while increasing the porosity); and 4) the substrate is easy to produce and handle. In addition, through good use of the advantage resulting from the flexibility of 1) above, there is also an advantage in that 5) the LDH separator including the polymer porous substrate can be easily bent or sealed and bonded. Specific examples of the polymer material include polystyrene, polyethersulfone, a polyolefin (e.g., polyethylene or polypropylene), an epoxy resin, polyphenylene sulfide, a fluororesin (e.g., a tetrafluororesin: PTFE), cellulose, nylon, and combinations thereof. Of those, polystyrene, polyethersulfone, a polyolefin (e.g., polyethylene or polypropylene), an epoxy resin, polyphenylene sulfide, a fluororesin (e.g., a tetrafluororesin: PTFE), nylon, and combinations thereof are preferred from the viewpoint that these materials are each a thermoplastic resin suitable for thermal pressing. Those materials each have alkali resistance as resistance to the electrolytic solution. The polymer material is more preferably a polyolefin, such as polypropylene or polyethylene, because of excellent hot-water resistance, acid resistance, and alkali resistance, and low cost, and is particularly preferably polypropylene or polyethylene. When the porous substrate is formed of a polymer material, it is particularly preferred that the LDH be incorporated over the entire thickness direction of the porous substrate (for example, most or nearly all pores inside the porous substrate be filled with the LDH). A commercially available polymeric microporous membrane may be used as such polymer porous substrate. As described above, in the LDH separator 16, the hardness, brittleness, and the like of the LDH, which is a ceramic material, are offset or reduced by the flexibility, toughness, and the like of the polymer porous substrate, and hence such excellent pressurization resistance and processability/assemblability as described above can be achieved while excellent characteristics resulting from the LDH are maintained.

Any appropriate LDH may be used as the LDH 16b as long as the pores of the polymer porous substrate can be clogged up to densify the LDH separator. Specifically, as the LDH, the LDH according to the embodiment of the present invention may be used, or any appropriate LDH other than the embodiment of the present invention may be used. The LDH according to the embodiment of the present invention is as described in the foregoing section A. As the other LDH, for example, the LDH described in the foregoing section C-1 may be used, or the LDH described in any of the above-mentioned international publications incorporated herein may be used.

The LDH separator 16 preferably has as small a number of the residual pores P (pores that are not clogged up with the LDH) as possible. The average porosity of the LDH separator resulting from the residual pores P thereof is, for example, 0.03% or more and less than 1.0%, preferably from 0.05% to 0.95%, more preferably from 0.05% to 0.9%, still more preferably from 0.05% to 0.8%, particularly preferably from 0.05% to 0.5%. When the average porosity falls within such ranges, the pores of the porous substrate 16a are sufficiently clogged up with the LDH 16b, and hence an extremely high degree of denseness can be achieved, with the result that a short circuit resulting from metal dendrites can be even more effectively suppressed. In addition, a significantly high ion conductivity can be achieved, and the LDH separator 16 can exhibit a sufficient function as a hydroxide ion conductive dense separator. The average porosity may be obtained by: a) cross-sectionally polishing the LDH separator with a cross-section polisher (CP); b) capturing cross-sectional images of a functional layer in two fields of vision with a field emission scanning electron microscope (FE-SEM) at a magnification of 50,000 times; and c) calculating the porosity of each of the two fields of vision through use of image inspection software (e.g., HDevelop manufactured by MVTec Software) on the basis of image data on the captured cross-sectional images, followed by determination of the average value of the resultant porosities.

The LDH separator 16 typically has gas impermeability and/or water impermeability. In other words, the LDH separator 16 is so densified as to have gas impermeability and/or water impermeability. Herein, the expression “have gas impermeability” means that, when a helium gas is brought into contact with one surface side of a measurement object in water at a differential pressure of 0.5 atm, the generation of bubbles resulting from the helium gas is not observed from the other surface side. In addition, herein, the expression “have water impermeability” means that water brought into contact with one surface side of a measurement object does not permeate therethrough to the other surface side. With this configuration, the LDH separator 16 selectively allows only hydroxide ions to pass therethrough by virtue of its hydroxide ion conductivity, and can exhibit a function as a separator for a battery. Further, the configuration is extremely effective in preventing a short circuit between positive and negative electrodes by physically blocking penetration through the separator by metal dendrites produced at the time of charge. The LDH separator has hydroxide ion conductivity, and hence enables efficient movement of required hydroxide ions between a positive electrode and a negative electrode, with the result that charge-discharge reactions in the positive electrode and the negative electrode can be achieved.

The LDH separator 16 has a He permeability per unit area of preferably 3.0 cm/min·atm or less, more preferably 2.0 cm/min·atm or less, still more preferably 1.0 cm/min·atm or less. When the He permeability falls within such ranges, the permeation of metal ions in an electrolytic solution can be extremely effectively suppressed. It is conceived in principle that, as a result, the separator can effectively suppress the growth of metal dendrites when used for a metal-air secondary battery. The He permeability is measured through: a step of supplying a He gas to one surface of the separator to allow the He gas to permeate through the separator; and a step of calculating the He permeability to evaluate the denseness of the hydroxide ion conductive dense separator. The He permeability is calculated by the expression F/(P×S) through use of a permeation amount F of the He gas per unit time, a differential pressure P applied to the separator at the time of He gas permeation, and an area S of the membrane through which the He gas permeates. When gas permeability is evaluated using the He gas as just described, the presence or absence of denseness at an extremely high level can be evaluated, and as a result, such a high degree of denseness that a substance other than hydroxide ions (in particular, metal ions that cause metal dendrite growth) is prevented to the extent possible from permeating (allowed to permeate only in an extremely small amount) can be effectively evaluated. This is because the He gas has the smallest constituent unit among atoms or molecules that can constitute gases, and also has extremely low reactivity. That is, He does not form a molecule, and single He atoms constitute the He gas. Meanwhile, a hydrogen gas is constituted of H₂ molecules, and hence a single He atom is smaller as a gas constituent unit. In the first place, the H₂ gas is a flammable gas, and hence is dangerous. When the He gas permeability defined by the above-mentioned expression is adopted as an indicator as described above, objective evaluation for denseness can be simply performed irrespective of various sample sizes and differences in measurement conditions. Thus, whether or not the separator has sufficiently high denseness suited as a separator for a metal-air secondary battery can be evaluated simply, safely, and effectively.

The thickness of the separator 16 is, for example, from 5 μm to 200 μm.

Through combined use of the air electrode and the hydroxide ion conductive dense separator, the metal-air secondary battery to be obtained can simultaneously satisfy the advantages of: (i) being able to prevent both of a short circuit between positive and negative electrodes due to metal dendrites and the inclusion of carbon dioxide; (ii) being able to suppress the evaporation of water contained in the electrolytic solution; and (iii) having excellent charge-discharge performance.

### EXAMPLES

Now, the present invention is specifically described by way of Examples. However, the present invention is not limited to these Examples.

### Example 1

An aqueous medium containing 45 wt % of ultrapure water and 55 wt % of ethanol was prepared. 8.34 mmol of NiCl₂, 2.98 mmol of FeCl₃, 2.98 mmol of VCl₃, 0.31 mmol of CoCl₂, and 4.21 mmol of

Mn(NO₃)₂ were dissolved in the aqueous medium, and the whole was stirred for 10 minutes to prepare a solution. Acetylacetone was added to the solution. The addition amount of acetylacetone was 0.017% (molar ratio) with respect to the total amount of the Ni, Fe, V, Co, and Mn elements. The solution was stirred for 30 minutes, and then propylene oxide was added. The addition amount of propylene oxide was 0.24% (molar ratio) with respect to the total amount of the Ni, Fe, V, Co, and Mn elements. The solution was stirred for 1 minute, and then left to stand still for 3 hours. As a result, the solution gelled spontaneously. The resultant gel was further left to stand still for 24 hours, and as a result, became a sol spontaneously. The series of operations was performed at room temperature.

The resultant sol was separated by centrifugation, and the resultant particles were subjected to washing with water and washing with ethanol in the stated order (so that chlorides, a nitrate, a reaction byproduct, and the like were removed). After that, the particles were dried at room temperature, and then pulverized in a mortar to provide sample powder.

### Examples 2 to 10, Experimental Example 1, and Comparative Examples 1 to 3

Sample powders were obtained in the same manner as in Example 1 except that composition ratios shown in Table 1 were adopted.

### Experimental Examples 2-1 to 2-4

Sample powders were obtained in the same manner as in Example 1 except that composition ratios shown in Table 2 were adopted.

### Experimental Examples 3-1 and 3-2

Sample powders were obtained in the same manner as in Example 1 except that composition ratios shown in Table 3 were adopted.

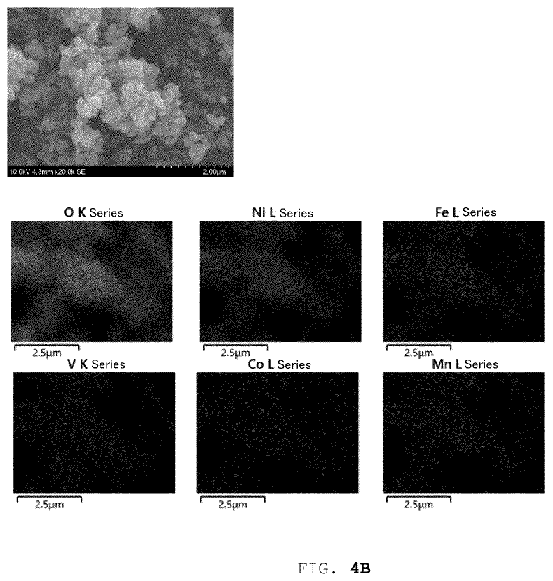

For each of the obtained samples, measurements described below were performed. An X-ray diffraction pattern of Example 1 is shown in FIG. 4A, and an SEM image and elemental mapping images of Example 1 are shown in FIG. 4B.

### 1. X-Ray Diffractometry

For each of the obtained samples, an X-ray diffraction pattern was obtained using RINT-TTRIII manufactured by Rigaku Corporation. Measurement conditions are as described below.
X-ray source: Cu-Kα ray
Output: 50 kV, 300 mA
Step angle: 0.020°
Scanning speed: 2.00°/min
Diffraction angle 2θ: 5° to 70°

### 2. SEM-EDX Measurement

For each of the obtained samples, elemental mapping was performed by energy-dispersive X-ray spectroscopy (SEM-EDX) using a scanning electron microscope (SEM). Specifically, composition analysis was performed with a scanning transmission electron microscope (SU3500 manufactured by Hitachi High-Technologies Corporation) and an energy-dispersive X-ray analyzer included therewith (manufactured by Horiba, Ltd., detector: X-MAX20, analyzer: EX-370) by: 1) capturing an image at an acceleration voltage of 10 kV and a magnification of 20,000 times; 2) performing three-point analysis at intervals of about 5 μm in the point analysis mode; 3) repeating the foregoing 1) and 2) one more time; and 4) calculating an average value for a total of six points.

As shown in FIG. 4A, peaks derived from an LDH (the above-mentioned first peak, second peak, and third peak) are found in the X-ray diffraction pattern of Example 1. Accordingly, it may be said that an LDH was obtained in Example 1. Peaks derived from LDHs were also similarly found in X-ray diffraction patterns of other Examples, Comparative Examples, and Experimental Examples.

As shown in FIG. 4B, in the elemental mapping images of Example 1, Ni, Fe, V, Co, and Mn have substantially identical mapping shapes, and these elements are present at nearly identical sites. Accordingly, it may be said that those elements are composited instead of being merely mixed. In addition, it was recognized that the results of the composition analysis corresponded to the loading ratios of the raw materials (salts). Results similar to those of Example 1 were also obtained in elemental mapping images of other Examples, Comparative Examples, and Experimental Examples.

[Evaluation of Catalytic Activity]

For each of the obtained samples, performance as a catalyst for the OER was evaluated using a rotating ring disk electrodes (RRDE) measurement method.

Specifically, a measurement apparatus used was a product manufactured under the product name “Rotating Ring Disk Electrode Apparatus” by BAS Inc. A platinum ring-glassy carbon (GC) disk electrode manufactured by BAS Inc. was used as an electrode. A 0.1 M aqueous solution of KOH was used as an electrolytic solution. 5 mg of each obtained sample and 3,000 μL of butanol were ultrasonically mixed for 1 hour to provide a liquid for measurement. 6 μL of the liquid for measurement was cast onto the disk electrode and dried, and then 4 μL of a 0.1 wt % Nafion (trademark, manufactured by Sigma-Aldrich Corporation) solution was further cast onto the disk electrode, followed by hydrodynamic voltammetry measurement at a number of rotations of 1,600 rpm and a chiller temperature of 25° C. under an oxygen atmosphere to determine an onset potential and a potential at a current density of 10 mA/cm 2 from a relationship between a potential with respect to a hydrogen electrode and a current density. The onset potential was defined as a potential at the time when AA/AV became 3.

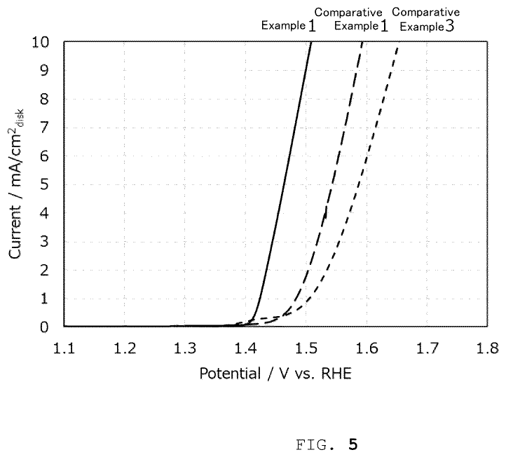

The evaluation results are shown in Tables 1 to 3. Further, a graph for comparing relationships between a potential with respect to a hydrogen electrode and a current density for Example 1, Comparative Example 1, and Comparative Example 3 is shown in FIG. 5.

TABLE 1

| | | | | | | | | | | | | | | | | | Po- |
|---|---|---|---|---|---|---|---|---|---|---|---|---|---|---|---|---|---|
| | | | | | | | | | | | | | | | | On- | ten- |
| | Ni | | | Fe | | | V | | | Co | | | Mn | | | set | tial |
| | | Blend- | | | Blend- | | | Blend- | | | Blend- | | | Blend- | | po- | at 10 |
| | Raw | ing | | Raw | ing | | Raw | ing | | Raw | ing | | | ing | | ten- | mA/ |
| | ma- | amount | Ra- | ma- | amount | Ra- | ma- | amount | Ra- | ma- | amount | Ra- | Raw | amount | Ra- | tial | cm² |
| | terial | (mmol) | tio | terial | (mmol) | tio | terial | (mmol) | tio | terial | (mmol) | tio | material | (mmol) | tio | (V) | (V) |
| Example | NiCl₂ | 8.34 | 0.44 | FeCl₃ | 2.98 | 0.16 | VCl₃ | 2.98 | 0.16 | CoCl₂ | 0.31 | 0.02 | Mn(NO₃)₂ | 4.21 | 0.22 | 1.389 | 1.511 |
| 1 | | | | | | | | | | | | | | | | | |
| Example | NiCl₂ | 9.37 | 0.50 | FeCl₃ | 2.97 | 0.16 | VCl₃ | 2.97 | 0.16 | CoCl₂ | 0.31 | 0.02 | Mn(NO₃)₂ | 3.13 | 0.17 | 1.393 | 1.593 |
| 2 | | | | | | | | | | | | | | | | | |
| Example | NiCl₂ | 7.50 | 0.40 | FeCl₃ | 2.97 | 0.16 | VCl₃ | 2.97 | 0.16 | CoCl₂ | 0.31 | 0.02 | Mn(NO₃)₂ | 5.00 | 0.27 | 1.383 | 1.520 |
| 3 | | | | | | | | | | | | | | | | | |
| Example | NiCl₂ | 9.38 | 0.43 | FeCl₃ | 2.97 | 0.14 | VCl₃ | 2.97 | 0.14 | CoCl₂ | 0.31 | 0.01 | Mn(NO₃)₂ | 6.25 | 0.29 | 1.401 | 1.553 |
| 4 | | | | | | | | | | | | | | | | | |
| Example | NiCl₂ | 12.50 | 0.65 | FeCl₃ | 2.97 | 0.15 | VCl₃ | 2.97 | 0.15 | CoCl₂ | 0.31 | 0.02 | Mn(NO₃)₂ | 0.63 | 0.03 | 1.432 | 1.583 |
| 5 | | | | | | | | | | | | | | | | | |
| Example | NiCl₂ | 12.50 | 0.57 | FeCl₃ | 2.97 | 0.14 | VCl₃ | 2.97 | 0.14 | CoCl₂ | 0.31 | 0.01 | Mn(NO₃)₂ | 3.13 | 0.14 | 1.444 | 1.602 |
| 6 | | | | | | | | | | | | | | | | | |
| Example | NiCl₂ | 12.50 | 0.50 | FeCl₃ | 2.97 | 0.12 | VCl₃ | 2.97 | 0.12 | CoCl₂ | 0.31 | 0.01 | Mn(NO₃)₂ | 6.25 | 0.25 | 1.437 | 1.597 |
| 7 | | | | | | | | | | | | | | | | | |
| Example | NiCl₂ | 12.50 | 0.66 | FeCl₃ | 1.49 | 0.08 | VCl₃ | 2.97 | 0.16 | CoCl₂ | 0.31 | 0.02 | Mn(NO₃)₂ | 1.62 | 0.09 | 1.437 | 1.773 |
| 8 | | | | | | | | | | | | | | | | | |
| Example | NiCl₂ | 12.50 | 0.67 | FeCl₃ | 2.98 | 0.16 | VCl₃ | 1.46 | 0.08 | CoCl₂ | 0.31 | 0.02 | Mn(NO₃)₂ | 1.53 | 0.08 | 1.452 | 1.773 |
| 9 | | | | | | | | | | | | | | | | | |
| Example | NiCl₂ | 12.50 | 0.67 | FeCl₃ | 2.96 | 0.16 | VCl₃ | 2.95 | 0.16 | CoCl₂ | 0.16 | 0.01 | Mn(NO₃)₂ | 0.17 | 0.01 | 1.445 | 1.773 |
| 10 | | | | | | | | | | | | | | | | | |
| Experi- | NiCl₂ | 12.50 | 0.67 | FeCl₃ | 2.97 | 0.16 | VCl₃ | 2.97 | 0.16 | CoCl₂ | 0.31 | 0.02 | — | — | — | 1.416 | 1.554 |
| mental | | | | | | | | | | | | | | | | | |
| Example | | | | | | | | | | | | | | | | | |
| 1 | | | | | | | | | | | | | | | | | |
| Com- | NiCl₂ | 12.50 | 0.67 | FeCl₃ | 1.25 | 0.07 | VCl₃ | 5.00 | 0.27 | — | — | — | — | — | — | 1.452 | 1.593 |
| parative | | | | | | | | | | | | | | | | | |
| Example | | | | | | | | | | | | | | | | | |
| 1 | | | | | | | | | | | | | | | | | |
| Com- | NiCl₂ | 12.50 | 0.67 | FeCl₃ | 5.00 | 0.27 | — | — | — | CoCl₂ | 1.25 | 0.06 | — | — | — | 1.478 | 1.773< |
| parative | | | | | | | | | | | | | | | | | |
| Example | | | | | | | | | | | | | | | | | |
| 2 | | | | | | | | | | | | | | | | | |
| Com- | NiCl₂ | 12.50 | 0.66 | FeCl₃ | 6.30 | 0.34 | — | — | — | — | — | — | — | — | — | 1.540 | 1.654 |
| parative | | | | | | | | | | | | | | | | | |
| Example | | | | | | | | | | | | | | | | | |
| 3 | | | | | | | | | | | | | | | | | |

TABLE 2

| | | | | | | | | | | | | | | | | | Po- |
|---|---|---|---|---|---|---|---|---|---|---|---|---|---|---|---|---|---|
| | | | | | | | | | | | | | | | | On- | ten- |
| | Ni | | | Fe | | | V | | | Co | | | Al | | | set | tial |
| | | Blend- | | | Blend- | | | Blend- | | | Blend- | | | Blend- | | po- | at 10 |
| | Raw | ing | | Raw | ing | | Raw | ing | | Raw | ing | | | ing | | ten- | mA/ |
| | ma- | amount | Ra- | ma- | amount | Ra- | ma- | amount | Ra- | ma- | amount | Ra- | Raw | amount | Ra- | tial | cm² |
| | terial | (mmol) | tio | terial | (mmol) | tio | terial | (mmol) | tio | terial | (mmol) | tio | material | (mmol) | tio | (V) | (V) |
| Experi- | NiCl₂ | 12.50 | 0.67 | FeCl₃ | 1.88 | 0.10 | VCl₃ | 3.75 | 0.20 | CoCl₂ | 0.31 | 0.02 | AlCl₃ | 0.31 | 0.02 | 1.419 | 1.662 |
| mental | | | | | | | | | | | | | | | | | |
| Example | | | | | | | | | | | | | | | | | |
| 2-1 | | | | | | | | | | | | | | | | | |
| Experi- | NiCl₂ | 12.50 | 0.67 | FeCl₃ | 2.81 | 0.15 | VCl₃ | 2.81 | 0.15 | CoCl₂ | 0.31 | 0.02 | AlCl₃ | 0.31 | 0.02 | 1.430 | 1.592 |
| mental | | | | | | | | | | | | | | | | | |
| Example | | | | | | | | | | | | | | | | | |
| 2-2 | | | | | | | | | | | | | | | | | |
| Experi- | NiCl₂ | 12.50 | 0.67 | FeCl₃ | 2.19 | 0.12 | VCl₃ | 2.50 | 0.13 | CoCl₂ | 0.63 | 0.03 | AlCl₃ | 0.98 | 0.05 | 1.421 | 1.609 |
| mental | | | | | | | | | | | | | | | | | |
| Example | | | | | | | | | | | | | | | | | |
| 2-3 | | | | | | | | | | | | | | | | | |
| Experi- | NiCl₂ | 12.50 | 0.67 | FeCl₃ | 1.31 | 0.07 | VCl₃ | 2.63 | 0.14 | CoCl₂ | 0.44 | 0.02 | AlCl₃ | 1.88 | 0.10 | 1.443 | 1.632 |
| mental | | | | | | | | | | | | | | | | | |
| Example | | | | | | | | | | | | | | | | | |
| 2-4 | | | | | | | | | | | | | | | | | |
| Experi- | NiCl₂ | 12.50 | 0.67 | FeCl₃ | 2.97 | 0.16 | VCl₃ | 2.97 | 0.16 | CoCl₂ | 0.31 | 0.02 | — | — | — | 1.416 | 1.554 |
| mental | | | | | | | | | | | | | | | | | |
| Example | | | | | | | | | | | | | | | | | |
| 1 | | | | | | | | | | | | | | | | | |
| Com- | NiCl₂ | 12.50 | 0.67 | FeCl₃ | 1.25 | 0.07 | VCl₃ | 5.00 | 0.27 | — | — | — | — | — | — | 1.452 | 1.593 |
| parative | | | | | | | | | | | | | | | | | |
| Example | | | | | | | | | | | | | | | | | |
| 1 | | | | | | | | | | | | | | | | | |
| Com- | NiCl₂ | 12.50 | 0.67 | FeCl₃ | 5.00 | 0.27 | — | — | — | CoCl₂ | 1.25 | 0.06 | — | — | — | 1.478 | 1.773< |
| parative | | | | | | | | | | | | | | | | | |
| Example | | | | | | | | | | | | | | | | | |
| 2 | | | | | | | | | | | | | | | | | |
| Com- | NiCl₂ | 12.50 | 0.66 | FeCl₃ | 6.30 | 0.34 | — | — | — | — | — | — | — | — | — | 1.540 | 1.654 |
| parative | | | | | | | | | | | | | | | | | |
| Example | | | | | | | | | | | | | | | | | |
| 3 | | | | | | | | | | | | | | | | | |

TABLE 3

| | | | | | | | | | | | | | | | | | Po- |
|---|---|---|---|---|---|---|---|---|---|---|---|---|---|---|---|---|---|
| | | | | | | | | | | | | | | | | On- | ten- |
| | Ni | | | Fe | | | V | | | Co | | | Zn | | | set | tial |
| | | Blend- | | | Blend- | | | Blend- | | | Blend- | | | Blend- | | po- | at 10 |
| | Raw | ing | | Raw | ing | | Raw | ing | | Raw | ing | | | ing | | ten- | mA/ |
| | ma- | amount | Ra- | ma- | amount | Ra- | ma- | amount | Ra- | ma- | amount | Ra- | Raw | amount | Ra- | tial | cm² |
| | terial | (mmol) | tio | terial | (mmol) | tio | terial | (mmol) | tio | terial | (mmol) | tio | material | (mmol) | tio | (V) | (V) |
| Experi- | NiCl₂ | 12.50 | 0.59 | FeCl₃ | 2.97 | 0.14 | VCl₃ | 2.97 | 0.14 | CoCl₂ | 0.31 | 0.01 | Zn(NO₃)₂ | 2.54 | 0.12 | 1.412 | 1.581 |
| mental | | | | | | | | | | | | | | | | | |
| Example | | | | | | | | | | | | | | | | | |
| 3-1 | | | | | | | | | | | | | | | | | |
| Experi- | NiCl₂ | 8.33 | 0.44 | FeCl₃ | 2.98 | 0.16 | VCl₃ | 3.01 | 0.16 | CoCl₂ | 0.32 | 0.02 | Zn(NO₃)₂ | 4.18 | 0.22 | 1.465 | 1.592 |
| mental | | | | | | | | | | | | | | | | | |
| Example | | | | | | | | | | | | | | | | | |
| 3-2 | | | | | | | | | | | | | | | | | |
| Experi- | NiCl₂ | 12.50 | 0.67 | FeCl₃ | 2.97 | 0.16 | VCl₃ | 2.97 | 0.16 | CoCl₂ | 0.31 | 0.02 | — | — | — | 1.416 | 1.554 |
| mental | | | | | | | | | | | | | | | | | |
| Example | | | | | | | | | | | | | | | | | |
| 1 | | | | | | | | | | | | | | | | | |
| Com- | NiCl₂ | 12.50 | 0.67 | FeCl₃ | 1.25 | 0.07 | VCl₃ | 5.00 | 0.27 | — | — | — | — | — | — | 1.452 | 1.593 |
| parative | | | | | | | | | | | | | | | | | |
| Example | | | | | | | | | | | | | | | | | |
| 1 | | | | | | | | | | | | | | | | | |
| Com- | NiCl₂ | 12.50 | 0.67 | FeCl₃ | 5.00 | 0.27 | — | — | — | CoCl₂ | 1.25 | 0.06 | — | — | — | 1.478 | 1.773< |
| parative | | | | | | | | | | | | | | | | | |
| Example | | | | | | | | | | | | | | | | | |
| 2 | | | | | | | | | | | | | | | | | |
| Com- | NiCl₂ | 12.50 | 0.66 | FeCl₃ | 6.30 | 0.34 | — | — | — | — | — | — | — | — | — | 1.540 | 1.654 |
| parative | | | | | | | | | | | | | | | | | |
| Example | | | | | | | | | | | | | | | | | |
| 3 | | | | | | | | | | | | | | | | | |

As apparent from Table 1 and FIG. 5, Examples (quinary) each have a small onset potential and/or a small potential at a current density of 10 mA/cm 2 as compared to those of Comparative Example 1 (ternary) and Comparative Example 3 (binary).

[Charge-Discharge Test]

For each of Example 1 and Comparative Example 3, a charge-discharge test was performed by the following procedure.

(Production of Air Electrode)

### Example 1

An aqueous medium containing 45 wt % of ultrapure water and 55 wt % of ethanol was prepared. 8.34 mmol of NiCl₂, 2.98 mmol of FeCl₃, 2.98 mmol of VCl₃, 0.31 mmol of CoCl₂, and 4.21 mmol of

Mn(NO₃)₂ were dissolved in the aqueous medium, and the whole was stirred for 10 minutes to prepare a solution. Acetylacetone was added to the solution. The addition amount of acetylacetone was 0.017% (molar ratio) with respect to the total amount of the Ni, Fe, V, Co, and Mn elements. The solution was stirred for 30 minutes, and then propylene oxide was added. The addition amount of propylene oxide was 0.24% (molar ratio) with respect to the total amount of the Ni, Fe, V, Co, and Mn elements. The solution was stirred for 1 minute, and carbon paper measuring 3 cm by 3 cm (manufactured by SGL Carbon, product name: “Sigracet (trademark)”) was impregnated with the resultant solution and then left to stand still for 3 hours. As a result, the solution gelled spontaneously. The resultant gel was further left to stand still for 24 hours, and as a result, became a sol spontaneously. The series of operations was performed at room temperature. The surface of the treated carbon paper was washed with ion-exchanged water, followed by drying in a dryer at 80° C. for 3 hours. Thus, an air electrode was obtained.

### Comparative Example 3

An air electrode was obtained in the same manner as in Example 1 except that composition ratios shown in Table 1 were adopted.

(Production of Cell for Evaluation)

Such a cell for evaluation as illustrated in FIG. 1 was produced. Specifically, a metal zinc plate (negative electrode) was placed in a container, a nonwoven fabric (not shown in FIG. 1) was arranged thereon, and a 5.4 M aqueous solution of KOH (electrolytic solution) was added at such a level as to be above the lower surface of a separator in the cell for evaluation to be obtained, and as not to reach the upper surface of the separator. Then, the separator and the air electrode obtained in the foregoing were arranged in the stated order on the nonwoven fabric. Thus, the cell for evaluation was obtained.

(Evaluation)

The obtained cell for evaluation (air electrode side) was subjected to a charge-discharge test under water vapor saturation (25° C.) and an oxygen gas flow (200 cc/min). An electrochemical measurement apparatus (manufactured by Hokuto Denko Corporation, “HZ-Pro S12”) was used for the charge-discharge test. At a charge-discharge current density of 8 mA/cm², 10 minutes of discharge was performed, and then 10 minutes of charge was performed (one cycle). A total of three cycles of this operation were performed.

An overvoltage at a capacity of 0.5 mAh in the 2nd cycle was 0.616 V in Example 1, and was 0.762 V in Comparative Example 3. It is conceived that, in Example 1, the charge-discharge reaction was promoted more to decrease the overvoltage.

### INDUSTRIAL APPLICABILITY

The layered double hydroxide according to the embodiment of the present invention can be suitably used as a catalyst for an air electrode of a metal-air secondary battery.

What is claimed is:

1. A layered double hydroxide, comprising four elements of Ni, Fe, V, and Co, and further comprising Mn as a fifth element.

2. The layered double hydroxide according to claim 1, wherein the layered double hydroxide has an atomic ratio (Ni+Mn)/(Ni+Fe+V+Co+Mn) of 0.6 or more and 0.8 or less, which is determined by energy-dispersive X-ray spectroscopy (EDS).

3. The layered double hydroxide according to claim 1, wherein the layered double hydroxide has an atomic ratio Mn/Ni of 0.2 or more and 0.8 or less, which is determined by energy-dispersive X-ray spectroscopy (EDS).

4. The layered double hydroxide according to claim 1, wherein the layered double hydroxide has an atomic ratio Mn/(Ni+Fe+V+Co+Mn) of more than 0 and 0.4 or less, which is determined by energy-dispersive X-ray spectroscopy (EDS).

5. A method of producing the layered double hydroxide of any one of claim 1, the method comprising:
preparing a solution of salts of Ni, Fe, V, Co, and Mn dissolved in an aqueous medium at respective predetermined molar ratios;
adding acetylacetone during the preparing a solution or after the preparing;
adding propylene oxide to the solution having added thereto acetylacetone; and
leaving the solution having added thereto propylene oxide to stand for a predetermined period of time.

6. The production method according to claim 5, comprising:
leaving the solution having added thereto propylene oxide to stand for a predetermined period of time to provide a gel; and
leaving the gel to stand for a predetermined period of time to provide a sol.

7. An air electrode, comprising:
a porous current collector; and
a catalyst layer containing the layered double hydroxide of any one of claim 1, the catalyst layer covering at least part of the porous current collector.

8. A metal-air secondary battery, comprising:
the air electrode of claim 7;
a separator;
an electrolytic solution; and
a metal negative electrode.

9. The metal-air secondary battery according to claim 8,
wherein the separator is a hydroxide ion conductive dense separator, and
wherein the electrolytic solution is separated from the air electrode by the separator.
